(19) United States
(12) Patent Application Publication
(10) Pub. No.: US 2025/0376356 A1
(43) Pub. Date: Dec. 11, 2025

(54) RAIL HANDLING TOOL

(71) Applicant: Caterpillar Inc., Peoria, IL (US)

(72) Inventors: Norbert T. AUFFARTH, Maxhuette-Haidhof (DE); Bhaskara DADDUPADUVARI, Dunlap, IL (US); Zhaoxu DONG, Dunlap, IL (US); Matthew FILBY, Lincolnshire (GB)

(73) Assignee: Caterpillar Inc., Peoria, IL (US)

(21) Appl. No.: 18/736,981

(22) Filed: Jun. 7, 2024

(51) Int. Cl. B66C 1/44

(52) U.S. Cl. CPC B66C 1/44

(57) ABSTRACT

A rail handling tool may include a mounting plate including a top end, a bottom end, and a pair of side ends. The rail handling tool may include a plurality of rail holding members extending from the bottom end of the mounting plate. The rail handling tool may include an actuator assembly configured to, at least one of, lock or unlock the plurality of rail holding members in unison.

### TECHNICAL FIELD

The present disclosure relates generally to lifting devices, and more particularly, to a rail handling tool.

### BACKGROUND

Dynamic energy transfer (“DET”), which includes charging while moving (CWM), refers to charging an electric machine while that machine is moving. In a typical setup, a DET system may comprise conductors, such as conductive rail assemblies having three rails for carrying electricity, and conductor support infrastructure, such as poles which support the rail assemblies at elevated positions along a roadway, track, or other movement pathway. The installation of these rail assemblies with the conductor support infrastructure is expensive and consumes significant time and resources. Particularly, lifting the rail assemblies from a storage location onto the poles may pose a significant challenge due to the shape and weight of the rail assemblies.

Previous lifting devices, such as that disclosed in MR ‘Fixed’ Multi Rail Grabs, Camlock, include clamps used in pairs to retain the rail sections rigidly in the flange toe to flange toe position. In such devices, rails are locked on to the clamp by swiveling feet that locate under the rail-head, and a top clamp body that rotates in a cam action pressing a hard rubber-lined horizontal curved beam onto the top of the rail-head. However, these devices require the use of complicated locking devices to grab and release rails

The rail handling tool of the present disclosure may solve one or more of the problems set forth above and/or other problems in the art. The scope of the current disclosure, however, is defined by the attached claims, and not by the ability to solve any specific problem.

### SUMMARY

In one aspect, the disclosure relates to a rail handling tool, including a mounting plate including a top end, a bottom end, and a pair of side ends. The rail handling tool may further include a plurality of rail holding members extending from the bottom end of the mounting plate, and an actuator assembly configured to, at least one of, lock or unlock the plurality of rail holding members in unison.

In another aspect, the disclosure relates to a rail handling tool including a mounting plate including a top end, a bottom end, and a pair of side ends. The rail handling tool may further include only three rail holding members secured to the bottom end of the mounting plate, and an actuator assembly including a lock lever configured to, at least one of, lock or unlock the three rail holding members in unison, wherein the mounting plate, the three rail holding members, and the actuator assembly are substantially parallel to one another.

In another aspect, the disclosure relates to a rail handling tool including a generally rectangular mounting plate including a top end, a bottom end, and a pair of longitudinal ends. The rail handling tool may further include only three rail holding members extending from the bottom end of the mounting plate, a proximal-most end of the three rail holding members are separated by a distance in a range of approximately 210 mm to 310 mm, and the top end of the mounting plate has at least one centrally located opening for receiving a transport assembly connection.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is an example installation environment of a DET system, according to aspects of the disclosure.

FIG. 2 is a perspective view of the rail handling tool of FIG. 1.

FIG. 3A is a front view of the rail handling tool of FIG. 1 with the rail handling members in an open configuration.

FIG. 3B is a front view of the rail handling tool of FIG. 1 with the rail handling members in a closed configuration with the pin element spaced from the hook.

FIG. 3C is a front view of the rail handling tool of FIG. 1 with the rail handling members in a closed configuration with the pin element contacting the hook.

FIG. 4 is a perspective view of an alternative rail handling tool, according to aspects of the disclosure.

FIG. 5 provides a flowchart depicting an exemplary method for transporting a rail assembly using a rail handling tool, according to aspects of the disclosure.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

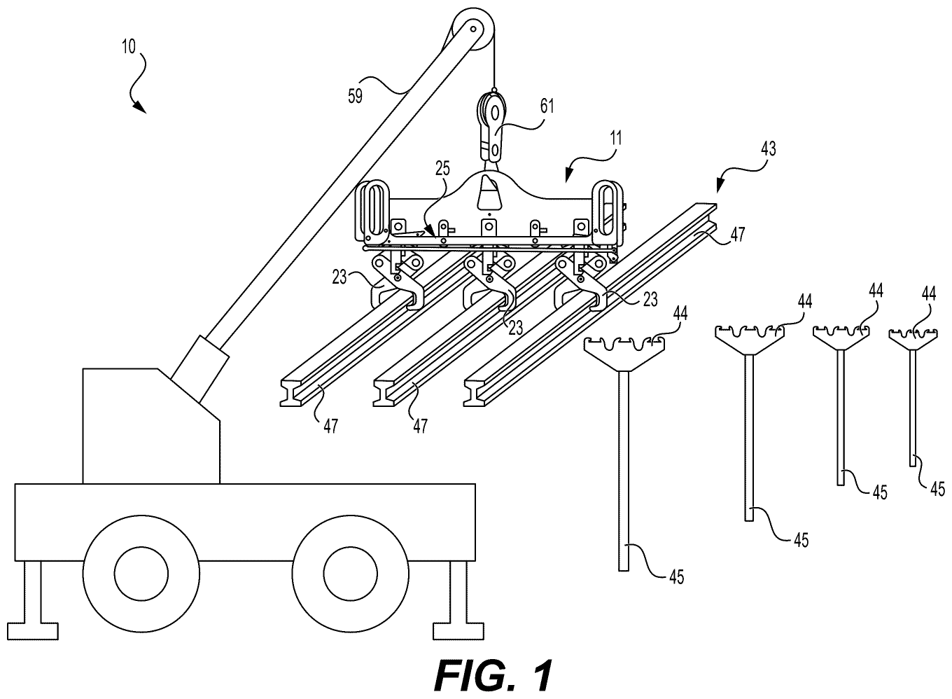

FIGS. 1-5 illustrate examples of a rail handling tool 11, and methods of use thereof. As will be explained in more detail below, the rail handling tool 11 may be used to grab rail assemblies 43 in order to transport them to a desired location. The rail handling tool 11 may have a number of rail holding members, rail grabs 23, that may grab and release an individual rail 47 within the rail assemblies 43. The rail handling tool 11 may further include an actuator assembly 25 that may be used to simultaneously lock the rail grabs 23 in either an open or closed position, and prevent the rail grabs 23 from opening when the rail assemblies 43 shift during transport.

Referring now to FIG. 1, an example installation environment of a DET system is shown, according to aspects of the disclosure. Within FIG. 1, the rail handling tool 11 is connected to a transport assembly that includes, for example a mobile crane 10. Mobile crane 10 is used to grab rail assembly 43 and position rail assembly 43 onto rail support brackets 44 on top of support poles 45. The mobile crane 10 may take any form and may include, for example, a boom 59 connected to a transport assembly connection, hook block 61, by a number of load lines. The hook block 61 may connect the mobile crane 10 to the rail handling tool 11. The mobile crane 10 may rotate and extend the boom 59, as well as raise and lower the rail handling tool 11 to move the rail assembly 43 clamped to the rail handling tool 11 from an initial position to a position atop the support poles 45.

In FIG. 1, the transport assembly is mobile crane 10. In other embodiments the transport assembly may be a stationary crane, a gantry crane, an overhead crane, a trailer based crane, a railcar based crane, a cherry picker, or another appropriate transport and lifting mechanism. In some examples, multiple transport assemblies, each connected to a rail handling tool 11, may be used to transport a single rail assembly 43. Additionally, the transport assembly connection may be another suitable means for attaching the rail handling tool 11 to the mobile crane 10.

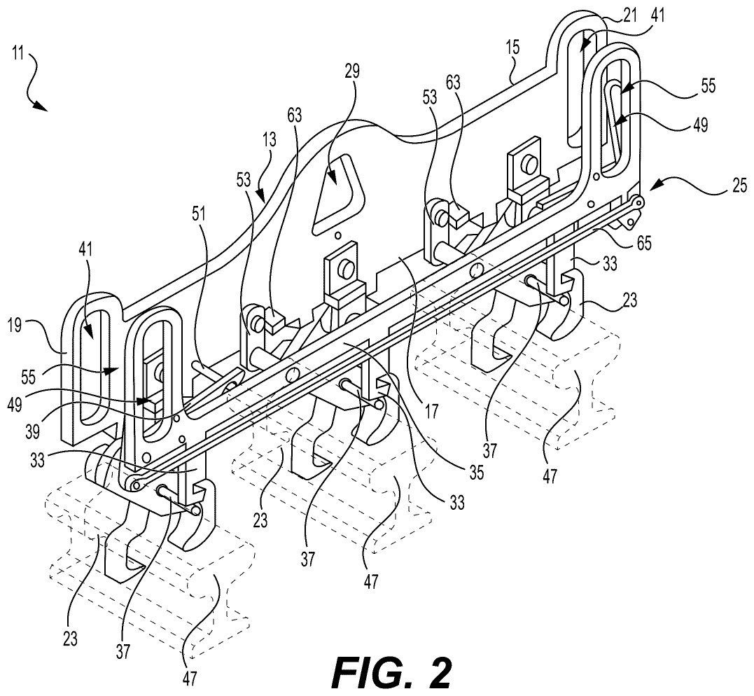

FIG. 2 is a perspective view of the rail handling tool 11 of FIG. 1. The rail handling tool 11 may include a mounting plate 13, a number of rail grabs 23, and an actuator assembly 25. The mounting plate 13 may be generally rectangular, such that mounting plate 13 has a top end 15, a bottom end 17, and a pair of longitudinal side ends, left end 19 and right end 21. The top end 15 of mounting plate 13 may include a centrally located opening, opening 29, for receiving the transport assembly connection, such as hook block 61 (FIG. 1). In some examples, the mounting plate 13 may include more than one opening 29 for receiving the hook block 61, and the openings 29 may be located in different positions. The mounting plate 13 may further include mounting plate handle openings 41 on the left end 19 and right end 21. The mounting plate handle openings 41 may be pill shaped such that their longitudinal axes extend a distance between the bottom end 17 and the top end 15 of the mounting plate 13. A bolt element 51 and a pair of stop blocks 63 may extend perpendicularly away from the mounting plate 13 towards actuator assembly 25.

The rail grabs 23 may extend from the bottom end 17 of the mounting plate 13 and be positioned between the mounting plate and the actuator assembly. Each of the rail grabs 23 may have a proximal end attached to the mounting plate 13 and a distal end extending downward away from the mounting plate 13. The rail grabs 23 may be scissor clamps made up of crisscrossed linkages interconnected by shared hinges. At the distal end of the rail grabs 23, the linkages may have detached free ends that may be shaped so as to receive a railhead of the rails 47 in the space between the free ends, as will be discussed further below. A pin element 37 may be mounted on a central hinge on the rail grabs 23, and extend in a direction normal to the mounting plate 13 and towards the actuator assembly 25.

The rail grabs 23 may actuate between a first, open position, and a second, closed position. In the open position, distance between the free ends at the distal end of each of the rail grabs 23 is larger than the width of a rail head of the rails 47. In the closed position, the distance between the free ends at the distal end of each of the rail grabs 23 is smaller than the width of the rail head of the rails 47. Due to the structure of the rail grabs 23, the distance between the distal end and the proximal end of the rail grabs 23 may be greater in the closed position than in the open position.

In the example rail handling tool 11 of FIGS. 1-3C, the rail grabs 23 are scissor clamps. In other examples, the rail holding members may be another suitable apparatus for grabbing and releasing the rails 47 within the rail assembly 43. Furthermore, the example rail handling tool 11 of FIGS. 1-3C includes only three rail holding members. In other examples, a different number of rail holding members may be used.

The distances between the rail grabs may correspond to the distance between the centers of the rails 47 of the rail assembly 43. In some examples, the rail grabs may be spaced apart such that the proximal-most ends of the rail grabs (where they are attached to mounting plate 13) are separated by a distance in the range of approximately 210 mm to 310 mm. Further, the proximal-most ends of the rail grabs may be spaced so as to together span a total distance of approximately 420 mm and 620 mm.

The actuator assembly 25 may include a crossbar 35 generally spanning the width of the mounting plate 13 and having crossbar handle openings 49 on its left and right ends, as well as a number of hooks 33 extending from the bottom of the crossbar 35. The crossbar handle openings 49 may be pill shaped and may be oriented such that longitudinal axes of the crossbar handle openings 49 are parallel with the longitudinal axes of the similarly shaped mounting plate handle openings 41.

The actuator assembly may further include a number of hooks 33 extending from the bottom of crossbar 35. Each hook 33 may be associated with a rail grab 23 of the rail handling device, and correspond to the pin element 37 of the associated rail grab 23. Each of the hooks 33 may have a slot that engages the pin elements 37 when the rail grabs 23 are in the open position, such that the pin elements 37 are retained within the slots when the rail grabs 23 are in the open position and the actuator assembly 25 is in the locked position (described below).

The actuator assembly 25 may also include release levers 55 connected by a connector arm 65 for actuating a releasable lock including catch 39 for securing the actuator assembly 25 in position. The release levers 55 may be pivotally mounted near the longitudinal ends of the crossbar 35 between the actuator assembly 25 and the mounting plate 2, such that a free end of each of the release levers 55 is accessible through both the respective crossbar handle openings 49 and the mounting plate handle openings 41. A connector arm 65 may extend between the release levers 55. The connector arm 65 may attach to one of release levers 55 opposite the pivot connection from the free end, and may attach to the other of the release levers 55 on the same side of the pivot connection as the free end. In this way, the connector arm 65 couples the motion of the two lever arms and causes them to pivot in opposite directions.

The actuator assembly 25 may also include an elongate catch 39 pivotally connected at one end to, for example, the release lever 55 on the left side of the actuator assembly 25. The free end of the catch 39 may include a groove for engaging the bolt element 51 attached to the mounting plate 13.

The actuator assembly 25 may be operatively connected to a face of the mounting plate 13 using two pivot arms 53, which may further include spacers to provide clearance between mounting plate 13 and the actuator assembly 25. A first pivot end of each of the pivot arms 53 may be pivotally connected to the mounting plate 13 between the center opening 29 and a respective longitudinal end of the mounting plate 13, and a second rotating end of the pivot arms 53 may be rotatably connected to the actuation assembly 25, between the center of the crossbar 35 and the respective longitudinal ends. The rotatable connection between the pivot arms 53 and the actuation assembly 25 allows the actuation assembly 25 to translate relative to the mounting plate 13 as the actuation assembly 25 moves with the rotating ends of the pivot arms 53. Each of the pivot arms 53 may be located to one side of a respective stop block 63, such that the stop blocks 63 limit the motion of the pivot arms 53.

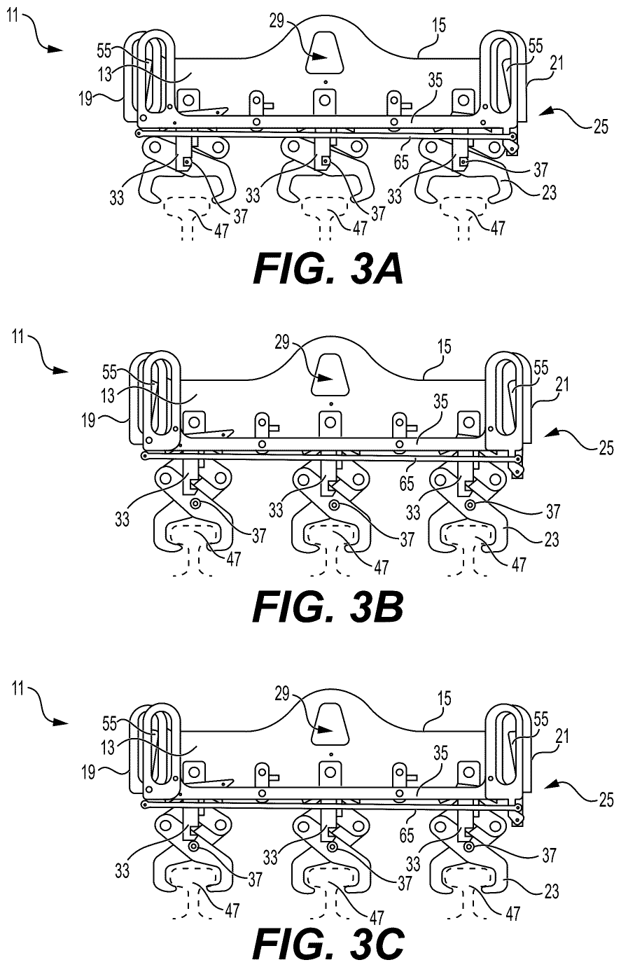

The actuation assembly 25 may be actuated between a first, locked position and a second, unlocked position. In the locked position, the longitudinal axis of the hooks 33 are aligned with the pin elements 37 extending from the rail grabs 23, and the catch 39 engages the bolt element 51 connected to the mounting plate 13, such that the actuator assembly 25 simultaneously locks all of the rail grabs 23 in unison. In this locked position of the actuation assembly 25, the engagement of the catch 39 to the bolt element 51 prohibits movement of the crossbar 35 to the left in FIG. 3A, and thus prohibiting the decoupling the hooks 33 from the pin elements 37 of the rail grabs 23. In the unlocked position, the catch 39 is disengaged from the bolt element 51 attached to the mounting plate 13, and the crossbar 35 is permitted to be shifted towards, for example, the left end 19 of the mounting plate 13, such that the longitudinal axes of the hooks 33 are no longer aligned with the pin elements 37 and the actuation assembly 25 simultaneously unlocks all of the rail grabs 23 in unison.

As can be seen in FIG. 3A, when the rail grabs 23 are in the open position, and the actuator assembly is in the locked position, the hooks 33 may engage the pin elements 37 of the rail grabs 23, such that the pin elements 37 of each of the rail grabs 23 are retained within the slots of respective hooks 33. As can be seen in FIG. 3B-3C, when the rail grabs 23 are in the closed position, and the actuator assembly is in the locked position, the hooks 33 may be positioned directly above the pin elements 37 of respective rail grabs 23.

As best seen in FIG. 3B, when the rail grabs 23 support the full weight of a rail 47 within the rail assembly 43, the weight of the rails 47 may act on the distal ends of the rail grabs 23 so as to extend and bias the rail grabs 23 towards the closed position. As best seen in FIG. 3C, when the rails shift within the rail grabs 23 such that weight of the rail 47 no longer acts to bias the rail grabs 23 towards the closed position, the hooks 33 may act as a stop for the pin elements 37 to prevent the rail grabs 23 from opening and potentially releasing the rails 47.

To actuate the actuator assembly 25 from the locked position to the unlocked position (e.g. from FIG. 3A to 3B), a user may squeeze either release lever 55, which may cause both release levers 55 to pivot. The pivoting motion of the release levers 55 cause the catch 39 to lift relative to the bolt element 51, disengaging the catch 39 from the bolt element 51. The user may also apply a lateral force that shifts the actuator assembly to the left in FIG. 3A to simultaneously disengage the hooks 33 from the pin elements 37, thus moving the actuator assembly 25 from the locked to the unlocked position.

To actuate the actuator assembly 25 from the unlocked position to the locked position, a user may first release the release levers 55, and then apply a lateral force to the actuator assembly to shift it back to its initial position. Once in the correct position, the catch 39 will reengage the bolt element 51, preventing further movement of the actuator assembly. In some examples, a spring may be included to automatically shift the actuator assembly 25 from the unlocked position to the locked position when the user releases the release levers 55.

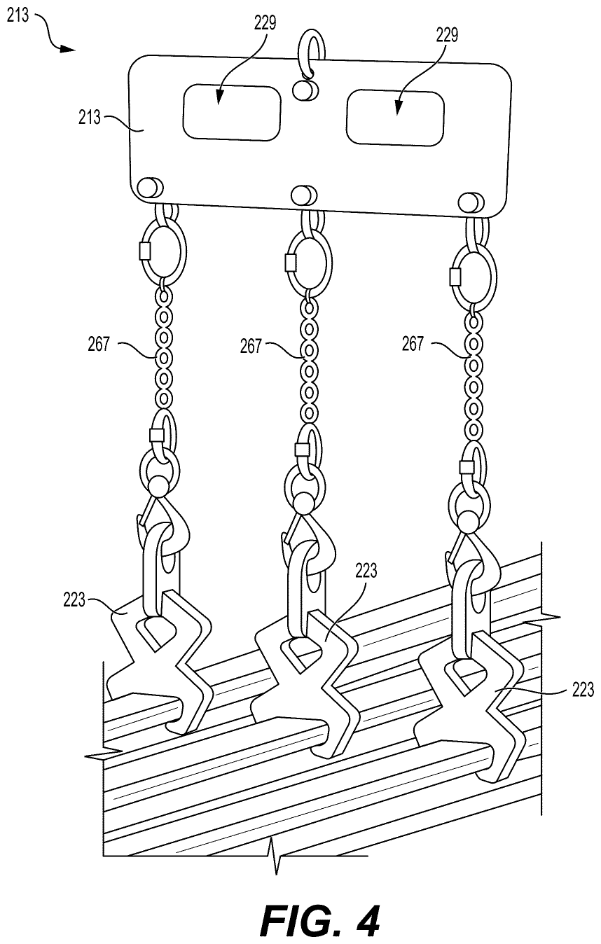

FIG. 4 is a perspective view of a rail handling tool 211, according to another aspect of this disclosure. In the example shown in FIG. 4, a rectangular mounting plate 213 is provided having multiple openings 229 for connection to a mobile crane 10. Chains 267 may be attached to the bottom of the mounting plate 213 at one end, and to rail grabs 223 on the other. The chains 267 and rail grabs 223 may be spaced so as to align with the center of the rails 47 within a rail assembly 43 as described above. While chains are shown in FIG. 4, any appropriate flexible connector could be used, such as, for example, cables, straps, ropes (collectively “tensile-only type connectors”). Rail grabs 223 are shown in solid form in FIG. 4, and thus can be engaged and disengaged from rails 47 by sliding them on and off at the ends of the rails 47. However, rail grabs 223 may be identical to rail grabs 23 and engaged and disengaged with the rails 47 based on the longitudinal extension of the rail grabs 23, as discussed above. The rail handling tool of FIG. 4 may provide a flexible extension between the mounting plate and the rail grabs 223 to assist in alignment and mounting of the rails 47 to the support poles 45.

### INDUSTRIAL APPLICABILITY

The disclosed aspects of the rail handling tool 11 of the present disclosure may be used to grab, release, and transport rail assemblies 43 to a desired location.

The rail handling tool 11 may be used to secure rail assemblies 43 for transport with a crane 10 or other movement device. The rail handling tool 11 may provide a system for attachment of rail assemblies to a transport device. The rail grabs 23 are spaced within the rail handling tool 11 so as to align with rails 47 of the rail assemblies 43 for placement on support poles 45. The rail handling tool also provides for a quick and reliable way to secure, transport, and release the rail assemblies 43 when installing the rails of a DETS system. The actuator assembly 25 provides a locking mechanism for simultaneously locking and unlocking the rail grabs 23 in either an open or closed position.

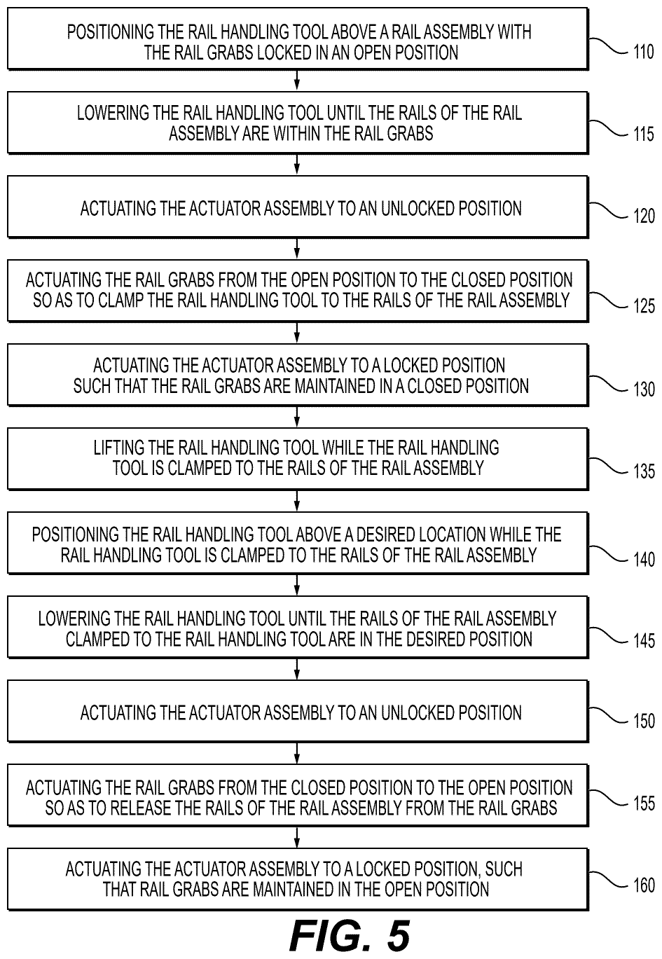

FIG. 5 provides a flowchart depicting an exemplary method for transporting a rail assembly using a rail handling tool 11, according to aspects of the disclosure. In step 110, the rail handling tool 11 is positioned above a rail assembly, with the rail grabs 23 locked in the open position (FIG. 3A) and aligned with the rails 47 of the rail assembly 43. In step 115, the rail handling tool 11 is lowered until the rails 47 of the rail handling assembly 43 are within the rail grabs 23. In step 120, the actuator assembly is actuated to the unlocked position via actuation of one of the release levers 55 and movement of the crossbar 35 to the left. In step 125, the rail grabs 23 are actuated from the open position to the closed position via extension of the rail grabs 23, so as to clamp the rail handling tool 11 to the rails 47 of the rail handling assembly 43. In step 130, the actuator assembly 25 is actuated back to the closed position via movement of the hooks 33 over center of the pin elements 37, such that the rail grabs are maintained in the closed position even if the rail grabs 23 are urged upward (FIG. 3C). In step 135, the rail handling tool 11 is lifted while it is clamped to the rails 47 of the rail assembly 43 (FIG. 1). In step 140, the rail handling tool 11 is positioned above a desired location, such as above the rail support brackets 44 on top of support poles 45, while the rail handling tool is clamped to the rails 47 of the rail assembly 43. In step 145, the rail handling tool 11 is lowered until the rails 47 of the rail assembly 43 clamped to the rail handling tool 11 are in the desired position, for example, within the rail support brackets 44 on top of support poles 45. In step 150, the actuator assembly is actuated to the unlocked position to allow the rail grabs 23 to further move to their open position. In step 155, the rail grabs 23 release the rails 47 of the rail assembly 43 from the rail grabs 23. In step 160, the actuator assembly is actuated to the locked position, such that the rail grabs are maintained in the open position.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A rail handling tool, comprising:
a mounting plate including a top end, a bottom end, and a pair of side ends;
a plurality of rail holding members extending from the bottom end of the mounting plate; and
an actuator assembly configured to, at least one of, lock or unlock the plurality of rail holding members in unison.

2. The rail handling tool of claim 1, wherein proximal-most ends of the plurality of rail holding members are separated by a distance in a range of approximately 210 mm to 310 mm.

3. The rail handling tool of claim 2, wherein the plurality of rail holding members consists of three rail holding members.

4. The rail handling tool of claim 3, wherein the proximal-most ends of the plurality of rail holding members span a distance of approximately 420 mm and 620 mm.

5. The rail handling tool of claim 1, wherein the top end of the mounting plate has at least one centrally located opening for receiving a transport assembly connection.

6. The rail handling tool of claim 1, wherein the actuator assembly is operatively connected to the mounting plate.

7. The rail handling tool of claim 1, wherein the actuator assembly includes a plurality of hooks, each hook associated with a rail holding members of the plurality of rail holding members.

8. The rail handling tool of claim 7, where the actuator assembly includes a lever, and the hooks extend from a bottom of the lever.

9. The rail handling tool of claim 7, wherein each of the plurality of rail holding members include a pin element, and wherein each of the hooks correspond to a pin element.

10. The rail handling tool of claim 1, further including a releasable lock for securing the actuator in position.

11. The rail handling tool of claim 10, wherein the releasable lock is releasable on both sides of the actuator.

12. The rail handling tool of claim 1, wherein both the mounting plate and the actuator assembly include handle openings on each side end.

13. A rail handling tool comprising:
a mounting plate comprising a top end, a bottom end, and a pair of side ends;
only three rail holding members secured to the bottom end of the mounting plate; and
an actuator assembly including a lock lever configured to, at least one of, lock or unlock the three rail holding members in unison;
wherein the mounting plate, the three rail holding members, and the actuator assembly are substantially parallel to one another.

14. The rail handling tool of claim 13, wherein proximal-most ends of the rail holding members are separated by a distance in a range of approximately 210 mm to 310 mm.

15. The rail handling tool of claim 13, wherein the proximal-most ends of the rail holding members span a distance of approximately 420 mm and 620 mm.

16. The rail handling tool of claim 13, wherein the top end of the mounting plate has at least one centrally located opening for receiving a transport assembly connection.

17. The rail handling tool of claim 13, wherein the actuator assembly is operatively connected to the mounting plate.

18. A rail handling tool comprising:
a generally rectangular mounting plate comprising a top end, a bottom end, and a pair of longitudinal ends;
only three rail holding members extending from the bottom end of the mounting plate, a proximal-most end of the three rail holding members are separated by a distance in a range of approximately 210 mm to 310 mm; and
the top end of the mounting plate has at least one centrally located opening for receiving a transport assembly connection.

19. The rail handling tool of claim 18, wherein the distance between the rail holding members corresponds to the distance between rails in a rail assembly.

20. The rail handling tool of claim 18, wherein the rail handling members are each connected to the mounting plate with a tensile-only type connector.
